(19) United States
(12) Patent Application Publication
(10) Pub. No.: US 2026/0005628 A1
(43) Pub. Date: Jan. 1, 2026

(54) SELF-CORRECTING FREQUENCY CONTROLLED VOLTAGE CONVERTER FOR BRUSHLESS DC MOTOR CURRENT LIMITING

(71) Applicant: Hamilton Sundstrand Space Systems International, Inc., Windsor Locks, CT (US)

(72) Inventors: Joshua Todd, Tolland, CT (US); Kevin G. Hawes, Tolland, MA (US); Gabriel Fletcher, Colchester, CT (US); Yuriy Kopytyuk, Chicopee, MA (US); Robert P. Wichowski, Westfield, MA (US); Raphael Shwapnil Sarkar, Glastonbury, CT (US); Nicholas Stoerm Van Derzee, Windsor Locks, CT (US)

(21) Appl. No.: 18/760,738

(22) Filed: Jul. 1, 2024

(51) Int. Cl. H02P 7/29; H02P 29/028; H02P 29/032

(52) U.S. Cl. CPC H02P 7/29; H02P 29/028; H02P 29/032

(57) ABSTRACT

A space based vehicle includes a controller configured to generate a pulse width modulation (PWM) control signal and output the PWM control signal at a control signal output. A self-correcting frequency controlled current limiter is connected to the control signal output. The self-correcting frequency current limiter provides a current limited control signal output and a buffered feedback loop output connected to a feedback input of the controller. A direct current (DC) motor includes a control input connected to the current limited control signal output and an instantaneous input current sensor.

### STATEMENT OF FEDERAL SUPPORT

This invention was made with Government support under a Government contract awarded by a United States Government Agency. The Government has certain rights in this invention.

### BACKGROUND

Exemplary embodiments pertain to the art of brushless direct current (DC) motor controls such as those included in space-based vehicles, spacecraft and other applications operated in similar environments. In some cases, mission parameters and/or conditions dictate that components cannot be replaced. Failure of a brushless DC motor driving mission critical functions ends the useful life of the system including the brushless DC motor when repair and/or replacement is not an option. Components limiting the useful life of the system in this manner are referred to as life-limiting components.

### BRIEF DESCRIPTION

Disclosed is a space based vehicle includes a controller configured to generate a pulse width modulation (PWM) control signal and output the PWM control signal at a control signal output. A self-correcting frequency controlled current limiter is connected to the control signal output. The self-correcting frequency current limiter provides a current limited control signal output and a buffered feedback loop output connected to a feedback input of the controller. A direct current (DC) motor includes a control input connected to the current limited control signal output and an instantaneous input current sensor.

In a further embodiment of the above the self-correcting frequency controlled current limiter is a voltage converter based current limiter.

In a further embodiment of any of the above the self-correcting frequency controlled current limiter includes an active band pass filter having a band pass filter input connected to the control signal output and a band pass filter output connected to a voltage buffer input of a voltage buffer gain stage, an output of the voltage buffer gain stage is connected a first active current limiter input and a feedback buffer, and the active current limiter including a second active current limiter input connected to an output of the instantaneous current sensor and including an output connected to the DC motor control input.

In a further embodiment of any of the above the band pass filter input is connected to the control signal output via a gain stage.

In a further embodiment of any of the above the active current limiter comprises a comparator configured to compare the first active current limiter input and the second active current limiter input, and provide an output of the first active current limiter input when the first active current limiter input is greater than or equal to the second active current limiter input and provide an output of 0 when the second active current limiter input is greater than or equal to the first active current limiter input.

In a further embodiment of any of the above the feedback buffer is an operational amplifier based voltage buffer and includes an output connected to a feedback input of the controller.

In a further embodiment of any of the above the controller is a field programmable gate array (FPGA).

In a further embodiment of any of the above the DC motor is a life-limiting component.

In a further embodiment of any of the above the space based-vehicle is an unmanned spacecraft.

Also disclosed is a method for extending a lifecycle of a spacecraft includes controlling a brushless DC motor using a feedback loop pulse width modulation (PWM) control signal, wherein the PWM control signal is current limited using a self-correcting frequency controlled current limiter.

In a further embodiment of any of the above the self-correcting frequency controlled current limiter prevents overcurrent events by comparing a buffered filtered PWM control signal and an instantaneous motor input current and setting the PWM control signal to 0 when the instantaneous motor input current exceeds the PWM control signal.

In a further embodiment of any of the above the method further includes receiving the PWM control signal at a current limiter input, amplifying the PWM control signal using a gain stage, providing the amplified PWM control signal to an active filter and actively filtering the amplified PWM control signal into a filtered PWM control signal, providing the filtered PWM control signal to a second gain stage and voltage buffering the filtered PWM control signal into the buffered filtered PWM control signal using the second gain stage, and providing the buffered filtered PWM control signal to an active current limiter and a feedback buffer.

In a further embodiment of any of the above comparing the buffered filtered PWM control signal and the instantaneous motor input current and setting an output PWM control signal to 0 when the instantaneous motor input current exceeds the buffered filtered PWM control signal is performed using the active current limiter.

In a further embodiment of any of the above comparing the buffered filtered PWM control signal and the instantaneous motor input current and setting an output PWM control signal to 0 when the instantaneous motor input current exceeds the buffered filtered PWM control signal further comprises passing the buffered filtered PWM control signal when the instantaneous motor input current is less than the buffered filtered PWM control signal.

In a further embodiment of any of the above the active current limiter is an operational amplifier based comparator.

In a further embodiment of any of the above the active filter is a band pass filter.

In a further embodiment of any of the above the gain stage is a transistor amplifier stage.

In a further embodiment of any of the above the feedback buffer is a unity gain voltage buffer.

In a further embodiment of any of the above, the method further includes operating at least one mission critical component using the brushless DC motor.

In a further embodiment of any of the above methods, the spacecraft is an unmanned spacecraft.

### BRIEF DESCRIPTION OF THE DRAWINGS

The following descriptions should not be considered limiting in any way. With reference to the accompanying drawings, like elements are numbered alike:

FIG. 1 Schematically illustrates a spacecraft including a brushless DC motor system;

FIG. 2 illustrates a high level schematic representation of a self-correcting current limiting frequency control voltage converter for the spacecraft of FIG. 1;

FIG. 3 illustrates a circuit diagram for one implementation of the self-correcting current limiting frequency control voltage converter of FIG. 2; and

FIG. 4 illustrates an operational flow of a self-correcting current limiting frequency control voltage converter in one example.

### DETAILED DESCRIPTION

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

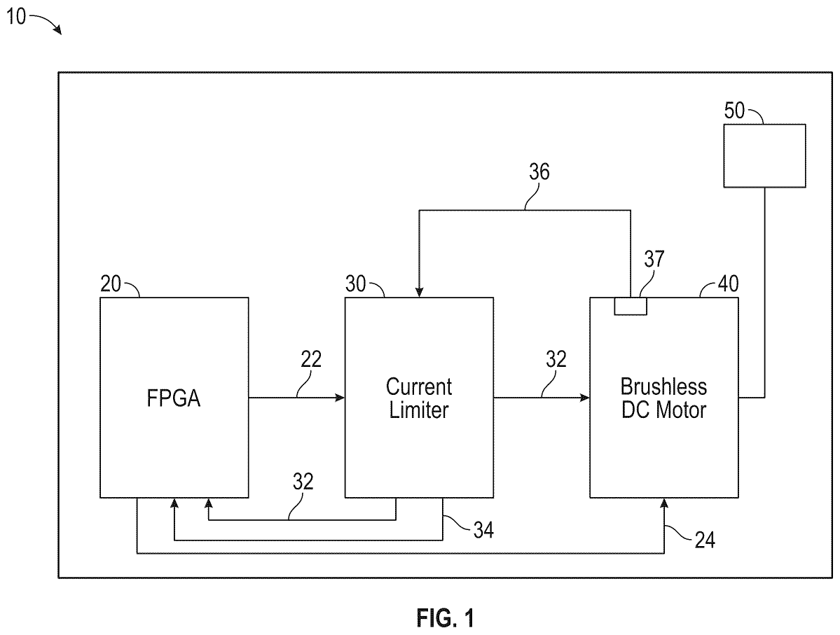

FIG. 1 schematically illustrates a spacecraft 10 including a field programmable gate array (FPGA) 20. The FPGA 20 is implemented as a pulse width modulation generator as well as a motor drive control. In alternate examples, alternate controllers such as microcontrollers, can be used in place of the FPGA 20 to generate a pulse width modulation (PWM) control signal without substantially modifying the remaining structures and processes. The FPGA 20 outputs a motor drive signal 24 that drives the brushless DC motor circuitry 40. The FPGA 20 additionally outputs a PWM control signal 22 to a current limiter circuit 30. The current limiter circuit 30 is a self-correcting frequency controlled voltage converter based current limiter and provides an over-current signal 32 to the FPGA 20 based on the detected motor phase current 36, which is the actual input current of the brushless DC motor circuit 40. The over-current signal 32 temporarily halts the FPGA 20 from outputting the motor drive signal 24 to temporarily reduce the current through the brushless DC motor circuitry 40.

Drive signals generated by the brushless DC motor circuit 40 drive are used to operate one or more components 50 on the spacecraft 10. The components 50 can include a valve, an actuator, a pump, or any similar component types and may be subsystems of other spacecraft systems. Certain component 50 functions, such as cooling pump valves, may be required for proper performance of the operational tasks of the spacecraft 10, and when operating such components 50 the brushless DC motor 40 is a life limiting component of the spacecraft 10.

PWM signals (PWM control signal 22 from the FPGA 20, converted to the over-current reference signal 34) generate a calculated current-limiting drive signal that temporarily halts the functionality of the brushless DC motor circuit 40 depending on the feedback for the current limiter. The FPGA 20 keeps a temporary count within a window of time such that a certain number of counts occurring within the window stop the FPGA 20 from outputting the motor drive signal 24 entirely and identify a mechanical or electrical fault within the brushless DC motor drive 40 or the components 50.

During operation, the function of the brushless DC motor circuit 40 can lag behind the operation commanded by the FPGA 20. In systems using a feedback based control, this lag results in momentary overshoots, where a current drawn through the brushless DC motor circuit 40 exceeds a desired current draw. The overshoot remains until a feedback signal provided from the brushless DC motor circuit 40 to the controller triggers a correction.

While momentary, the cumulative effect of the input current exceeding the commanded input current levels due to repeated overshoots is a reduced lifespan of the brushless DC motor circuit 40 as well as the components 50. As the components 50 are life-limiting components in the spacecraft 10, it is desirable to extend the lifecycle of the components 50 as long as possible by reducing the occurrence of overshoots.

A current sensor 37 detects an actual input current of the brushless DC motor circuit 40 and generates an input current signal 36 corresponding to the real time magnitude of the input current. The current sensor 37 can be any sensor arrangement able to detect the real-time input current of the brushless DC motor circuit 40. In one example, the current sensor 37 includes a sense resistor. The input current signal 36 is provided from the brushless DC motor circuit 40 to the current limiter 30. An over-current setpoint signal 34 is provided from the current limiter 30 to the FPGA 20. The over-current setpoint signal 34 is generated by a feedback buffer in the current limiter 30 and is provided back to the FPGA 20 to operate as closed loop feedback control operations.

In order to extend the operational life of the brushless DC motor circuit 40 and the components 50, the current limiter 30 compares the input current signal 36 to the converted PWM control signal 22 (a commanded setpoint) in real time and temporarily halts the motor drive signal 24 such that when the actual input current 36 begins to exceed the commanded setpoint, the motor drive signal 24 is temporarily decreased or set to zero. This operation eliminates overshoot current by limiting the input current to the brushless DC motor circuit 40 and, by extension, the input current to the components 50 to a predetermined operational bound.

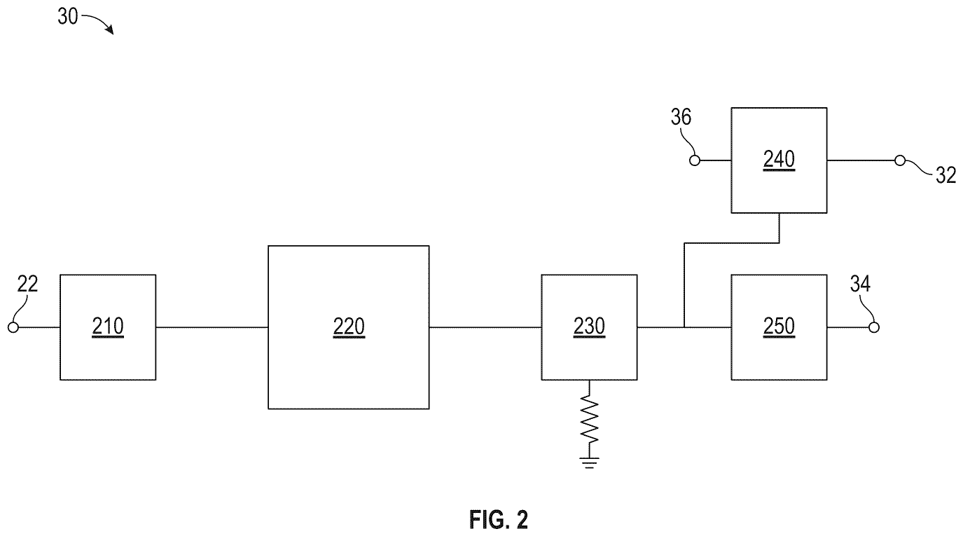

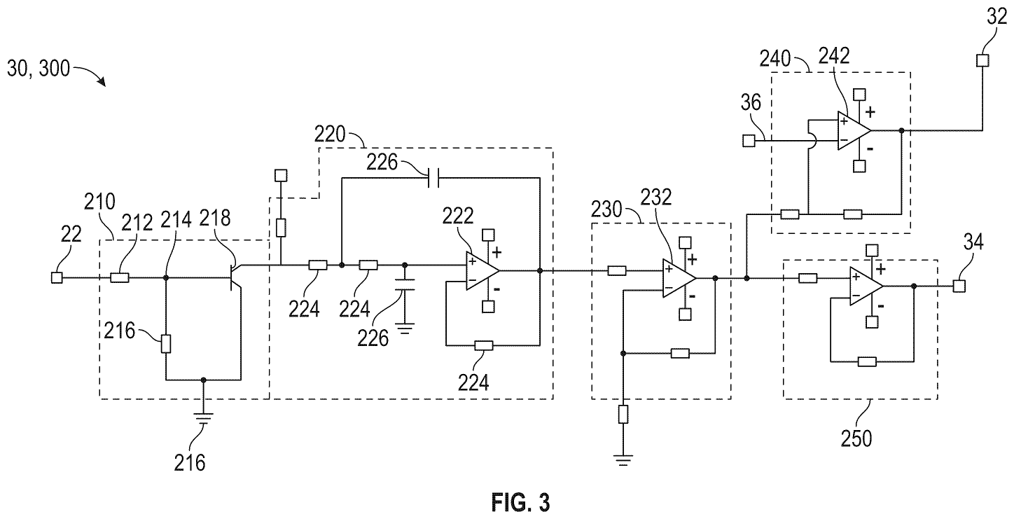

With continued reference to the spacecraft 10 of FIG. 1, FIG. 2 illustrates a high level schematic diagram of the current limiter 30 and FIG. 3 illustrates a circuit diagram 300 of one example circuit configured to implement the current limiter 30 of FIGS. 1 and 2. The particular resistances, capacitances, inductances, and other parameters of the electrical devices constructing the current limiter 30 depend on the practical implementation of the spacecraft 10, or other space based vehicle, in which the current limiter 30 is being implemented, and can be determined by one of skill in the art.

The current limiter 30 includes a gain stage 210 receiving the PWM control signal 22. The gain stage 210 amplifies the commanded control signal to a usable magnitude. In the example circuit of FIG. 3, the gain stage 210 includes a resistor 212 connecting the input commanded control signal 22 to a node 214. A second resistor 216 connects the node 214 to a ground 216. The node 214 is further connected to a base of a bipolar junction transistor (BJT) 218. An emitter of the BJT 218 is connected to the ground 216, and a collected of the BJT 218 is connected to an active filter 220.

The active filter 220 is a configurable filter and actively converts the PWM commanded control signal 22 to a DC setpoint signal, with the frequency band being set by the resistance and capacitance values of the active filter 220. In the example circuit of FIG. 3, the active filter 220 includes an operational amplifier (opamp) 222 and resistors 224 and capacitors 226 connected in an rc (resistive-capacitive) op-amp filter configuration.

The DC setpoint signal of the commanded control signal 22 is provided to a second gain stage 230 as an output of the active filter 220. The second gain stage 230 adjusts the levels of the control signal 22 to be suitable for comparison with the input current, and to be provided back to the FPGA 20 as an over-current setpoint signal 34. In the implementation of FIG. 3, the second gain stage 230 is implemented using an opamp 232 configured as a buffer based amplifier.

The amplified commanded control signal 22 is passed as an output of the second gain stage 230 is to both an active current limiter 240, and a feedback buffer 250.

The active current limiter 240 receives the instantaneous current draw 36 of the brushless DC motor 40 and the commanded control signal 22 as inputs and compares the two values, outputting an over-current signal 32 that is fed back to the FPGA 20 in the form of a flag. During normal operation, when the command control signal 22 is above the instantaneous current draw 36, the active current limiter 240 sets the flag to 0, signaling that the brushless DC motor circuit 40 is operating within designed parameters. When the commanded control signal 22 is at or below the instantaneous current draw 36, the command control signal 22, the active current limiter 240 sets the flag to 1. The flag value of 1 signals an over-current event. This, in turn, tells the FPGA 20 to temporarily cease the operation of the motor drive signal 24, temporarily halting the brushless DC motor circuit 40 and momentarily stopping the components 50 from operating. It is appreciated that those skilled in the art are capable of setting a counter in the FPGA 20 that counts the number of flags generated by an over-current signal 32 within a determined duration of time. Should the number of flags generated by the over-current signal 32 exceed the setpoint, the FPGA 20 can cease all motor drive functions entirely. In the example circuit 300 of FIG. 3, the active current limiter 240 is an opamp comparator 242 with inputs of the commanded control signal and the instantaneous input current 36.

The feedback buffer 250 receives the filtered and buffered commanded control signal 22 and to provide a voltage buffer on the control signal 22 before passing the over-current setpoint signal 34 to the FPGA 20. The voltage buffer operates at a unity gain, providing the same output as input and functions to provide a low impedance on the over-current setpoint signal 34. The FPGA 20 utilizes the buffered over-current setpoint signal 34 in a feedback control loop in order to ensure that the commanded control signal 22 is reaching the active current limiter 240 in the expected way.

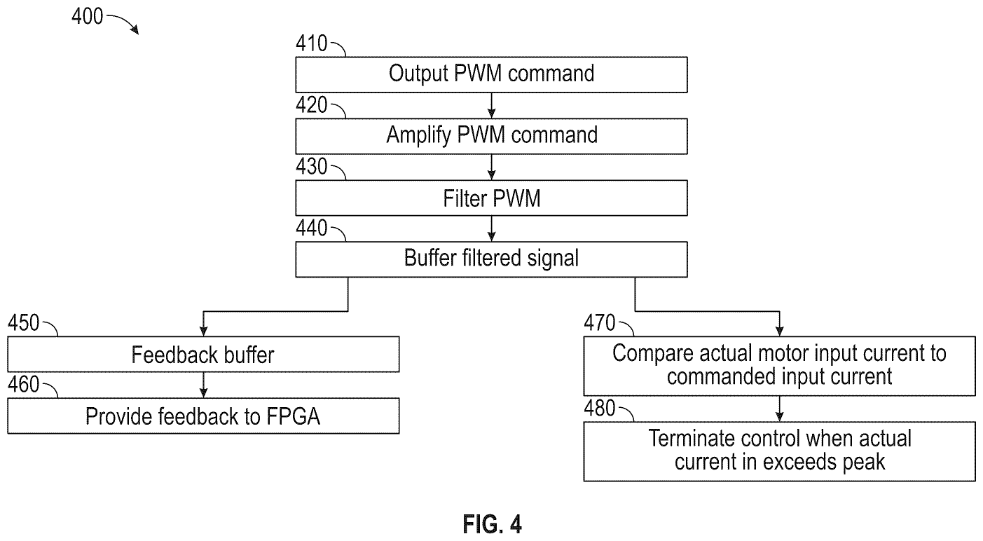

With continued reference to FIGS. 1-3, FIG. 4 illustrates an operational flow of a self-correcting current limiting frequency control voltage converter in one example. Initially, a PWM command signal is output to the current limiter 30 in an Output PWM Command step 410. The PWM command is then amplified using the first gain stage 210 in an Amplify PWM Command step 420.

The amplified PWM command is filtered using the active filter 220 to remove noise in a Filter PWM step 430, and the filtered PWM command is passed through a voltage buffer to generate an isolated command signal using a second gain stage in a Buffer Filtered Signal step 440.

The buffered signal is simultaneously passed to a feedback buffer in a Feedback Buffer step 450 and to an active current limiter for a comparison step 470. In the feedback buffer step 450, the signal is buffered and then provided to the controller in a Provide Feedback to FPGA step 460.

In the comparison step 470, the instantaneous motor current is compared to the commanded input current. When the commanded input current is less than the instantaneous current, the process 400 terminates the control signal in a termination step 480.

Implementation of the architecture illustrated in FIGS. 1-4 provides a feedback loop that self corrects the maximum operating limits of the system during operation and can substantially extend the lifecycle of the spacecraft 10, or any other similar system incorporating the current limiter 30.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A space based vehicle comprising:
a controller configured to generate a pulse width modulation (PWM) control signal and output the PWM control signal at a control signal output;
a self-correcting frequency controlled current limiter connected to the control signal output, the self-correcting frequency current limiter providing a current limited control signal output and a buffered feedback loop output connected to a feedback input of the controller; and
a direct current (DC) motor including a control input connected to the current limited control signal output and an instantaneous input current sensor.

2. The space based vehicle of claim 1, wherein the self-correcting frequency controlled current limiter is a voltage converter based current limiter.

3. The space based vehicle of claim 2, wherein the self-correcting frequency controlled current limiter comprises
an active band pass filter having a band pass filter input connected to the control signal output and a band pass filter output connected to a voltage buffer input of a voltage buffer gain stage;
an output of the voltage buffer gain stage is connected a first active current limiter input and a feedback buffer; and
the active current limiter including a second active current limiter input connected to an output of the instantaneous current sensor and including an output connected to the DC motor control input.

4. The space based vehicle of claim 3, wherein the band pass filter input is connected to the control signal output via a gain stage.

5. The space based vehicle of claim 3, wherein the active current limiter comprises a comparator configured to compare the first active current limiter input and the second active current limiter input, and provide an output of the first active current limiter input when the first active current limiter input is greater than or equal to the second active current limiter input and provide an output of 0 when the second active current limiter input is greater than or equal to the first active current limiter input.

6. The space based vehicle of claim 3, wherein the feedback buffer is an operational amplifier based voltage buffer and includes an output connected to a feedback input of the controller.

7. The space based vehicle of claim 1, wherein the controller is a field programmable gate array (FPGA).

8. The space based vehicle of claim 1, wherein the DC motor is a life-limiting component.

9. The space based vehicle of claim 1, wherein the space based-vehicle is an unmanned spacecraft.

10. A method for extending a lifecycle of a spacecraft comprising:
controlling a brushless DC motor using a feedback loop pulse width modulation (PWM) control signal, wherein the PWM control signal is current limited using a self-correcting frequency controlled current limiter.

11. The method of claim 10, wherein the self-correcting frequency controlled current limiter prevents overcurrent events by comparing a buffered filtered PWM control signal and an instantaneous motor input current and setting the PWM control signal to 0 when the instantaneous motor input current exceeds the PWM control signal.

12. The method of claim 11, further comprising:
receiving the PWM control signal at a current limiter input, amplifying the PWM control signal using a gain stage;
providing the amplified PWM control signal to an active filter and actively filtering the amplified PWM control signal into a filtered PWM control signal;
providing the filtered PWM control signal to a second gain stage and voltage buffering the filtered PWM control signal into the buffered filtered PWM control signal using the second gain stage; and
providing the buffered filtered PWM control signal to an active current limiter and a feedback buffer.

13. The method of claim 12, wherein comparing the buffered filtered PWM control signal and the instantaneous motor input current and setting an output PWM control signal to 0 when the instantaneous motor input current exceeds the buffered filtered PWM control signal is performed using the active current limiter.

14. The method of claim 13, wherein comparing the buffered filtered PWM control signal and the instantaneous motor input current and setting an output PWM control signal to 0 when the instantaneous motor input current exceeds the buffered filtered PWM control signal further comprises passing the buffered filtered PWM control signal when the instantaneous motor input current is less than the buffered filtered PWM control signal.

15. The method of claim 13, wherein the active current limiter is an operational amplifier based comparator.

16. The method of claim 12, wherein the active filter is a band pass filter.

17. The method of claim 12, wherein the gain stage is a transistor amplifier stage.

18. The method of claim 12, wherein the feedback buffer is a unity gain voltage buffer.

19. The method of claim 10, further comprising operating at least one mission critical component using the brushless DC motor.

20. The method of claim 10, wherein the spacecraft is an unmanned spacecraft.
